(19) United States
(12) Patent Application Publication
(10) Pub. No.: US 2015/0160497 A1
(43) Pub. Date: Jun. 11, 2015

(54) LIQUID CRYSTAL DISPLAY PANEL AND MANUFACTURING METHOD THEREOF

(71) Applicant: MITSUBISHI ELECTRIC CORPORATION, Tokyo (JP)

(72) Inventors: Shingo SONODA, Koshi-shi (JP); Akira TAMATANI, Koshi-shi (JP)

(73) Assignee: MITSUBISHI ELECTRIC CORPORATION, Tokyo (JP)

(21) Appl. No.: 14/557,760

(22) Filed: Dec. 2, 2014

(30) Foreign Application Priority Data
Dec. 5, 2013 (JP) 2013-251790

(51) Int. Cl. G02F 1/1339; G02F 1/1341

(52) U.S. Cl. CPC G02F 1/13394; G02F 1/1339; G02F 1/1341; G02F 2001/13415

(57) ABSTRACT

A liquid crystal display panel includes: two substrates, whose inner surfaces are formed with a display region, which are arranged to face each other and at least one of which is transparent; a liquid crystal material, which is sandwiched between the display region of the two substrates; a columnar spacer, which is formed on the inner surface of the substrate and on the outer periphery of the display region and maintains a gap between the two substrates; a first annular seal frame, which is continuously formed on the inner periphery of the columnar spacer and on the outer periphery of the display region; and a second annular seal frame, which is continuously formed on the outer periphery of the columnar spacer.

### CROSS-REFERENCE TO RELATED APPLICATION

This application claims priority from Japanese Patent Application No. 2013-251790 filed on Dec. 5, 2013, the entire subject matter of which is incorporated herein by reference.

### TECHNICAL FIELD

This disclosure relates to a liquid crystal display panel to configure a liquid crystal display device and a manufacturing method thereof. More specifically, this disclosure relates to a liquid crystal display panel using a one drop filling method and a manufacturing method thereof.

### BACKGROUND ART

In the manufacturing process of a liquid crystal display panel to configure a liquid crystal display device, conventionally, a vacuum filling method has been widely used. In this vacuum filling method, a liquid crystal display panel is formed in such a way that the periphery of two substrates are bonded to each other using a sealing material except for a portion (injection port) thereof. Pressure inside the liquid crystal display panel is depressurized in a vacuum chamber, and then the injection port is immersed into a liquid crystal material while the depressurized state is being maintained. Subsequently, when the pressure in the vacuum chamber returns to the atmospheric pressure, the liquid crystal material is drawn into the liquid crystal display panel by the capillary phenomenon and the pressure difference between the inside and outside of the liquid crystal display panel. In this way, the injection of the liquid crystal can be performed.

Although the vacuum filling method has a feature capable of using a device in a simple configuration, it takes a very long time to inject the liquid crystal material into the liquid crystal display panel. In the case of the liquid crystal display panel for a large television, it takes several tens of hours to inject the liquid crystal material thereinto. Further, for the liquid crystal display panel of the VA (Vertical Alignment) mode, it has been known to take a further long time.

Accordingly, an ODF (One Drop Filling) method capable of reducing the injection time has been suggested and widely used. In this one drop filling method, a closed annular seal frame is formed at the outer periphery of a display region on one substrate and a required amount of liquid crystal material is dropped into the seal frame. Then, superposition of the one substrate over a counter substrate is performed under reduced pressure, and then the reduced pressure returns to the atmospheric pressure. The liquid crystal display panel is pressed at the atmospheric pressure from the outside and the portion inside the liquid crystal display panel, where the liquid crystal is not injected, is depressurized. In this way, the liquid crystal display panel is pressed according to the pressure difference therebetween and therefore it is possible to obtain a desired panel gap.

The one drop filling method can greatly reduce the injection time and, in particular, an effect thereof is remarkable in a large liquid crystal display panel. However, in the case of using a single annular seal frame, after superposition, pressure is intensively applied to the portion inside the seal frame, where the liquid crystal is not injected. Therefore, the panel gap tends to be thin and unevenness in the panel gap occurs at the peripheral portion of the display region. As a result, display unevenness is visible.

Accordingly, there has been suggested a method of reducing the unevenness in the panel gap (e.g., JP-A-2002-244141). According to this method, an auxiliary seal frame is formed on the outside of the seal frame to obtain double seal frames, the superposition is performed in this state and then the whole of the gap of the double seal frames is depressurized. In this way, pressure is applied to a wide range and therefore it is possible to reduce the unevenness in the panel gap. Further, there has also been suggested a method that is capable of obtaining a liquid crystal display panel without unevenness in the panel gap by optimizing a spacing between the double seal frames and a distance between the seal frames and a liquid crystal dropping region (e.g., JP-A-2005-115155).

However, in the case of both structures using the double seal material disclosed in JP-A-2002-244141 and JP-A-2005-115155, a width of the seal region is widened and thus a so-called frame portion of a liquid crystal display panel is increased. When, in order to avoid such a situation, a substrate is cut at a portion between the double seals and the seal frame of the liquid crystal display panel, which is a double seal frame in a manufacturing process, is cut while leaving only a single seal frame, the seal material portion is cut simultaneously in the substrate cutting process. Accordingly, there is also a problem that cutting failure such as substrate chipping or substrate cracking is liable to occur.

### SUMMARY

This disclosure provides a liquid crystal display panel where unevenness in a panel gap does not occur and a peripheral region (frame region) of a display region is small by forming an annular seal frame, respectively, on the inner peripheral side and the outer peripheral side of a columnar spacer formed on an outer periphery of a display region of the liquid crystal display panel, and widening a width of the seal frames by pressing two substrates to configure the liquid crystal display panel and integrating the double seal frame with the columnar spacer.

A liquid crystal display panel of this disclosure includes: two substrates, whose inner surfaces are formed with a display region, which are arranged to face each other and at least one of which is transparent; a liquid crystal material, which is sandwiched between the display region of the two substrates; a columnar spacer, which is formed on the inner surface of the substrate and on the outer periphery of the display region and maintains a gap between the two substrates; a first annular seal frame, which is continuously formed on the inner periphery of the columnar spacer and on the outer periphery of the display region; and a second annular seal frame, which is continuously formed on the outer periphery of the columnar spacer.

The liquid crystal display panel of this disclosure includes the columnar spacer provided between the first and second seal frames. In this way, it is possible to obtain a liquid crystal display panel in which a peripheral region (frame region) of the liquid crystal display panel is narrow and unevenness in a panel gap is small.

### BRIEF DESCRIPTION OF THE DRAWINGS

The foregoing and additional features and characteristics of this disclosure will become more apparent from the following detailed descriptions considered with the reference to the accompanying drawings, wherein:

FIG. 1 is a schematic plan view of a liquid crystal display panel according to a first embodiment of this disclosure;

FIG. 2 is a schematic sectional view of the liquid crystal display panel according to the first embodiment of this disclosure;

FIGS. 3A and 3B are schematic views for explaining a manufacturing method of the liquid crystal display panel according to the first embodiment of this disclosure, and FIG. 3A is a schematic plan view thereof and FIG. 3B is a schematic sectional view thereof;

FIGS. 4A and 4B are schematic views for explaining a manufacturing method of the liquid crystal display panel according to the first embodiment of this disclosure, and FIG. 4A is a schematic plan view thereof and FIG. 4B is a schematic sectional view thereof;

FIGS. 5A and 5B are schematic views for explaining a manufacturing method of the liquid crystal display panel according to the first embodiment of this disclosure, and FIG. 5A is a schematic plan view thereof and FIG. 5B is a schematic sectional view thereof;

FIGS. 6A and 6B partially enlarged views showing a relationship between an in-seal columnar spacer and a seal frame in the first embodiment of this disclosure, and FIG. 6A shows a state before superposition and FIG. 6B shows a state after superposition;

FIG. 7 is an assembly process view of a liquid crystal display device according to the first embodiment of this disclosure;

FIGS. 8A and 8B are partially enlarged views showing a relationship between an in-seal columnar spacer and a seal frame in a second embodiment of this disclosure, and FIG. 8A shows a state before superposition and FIG. 8B shows a state after superposition;

FIGS. 9A and 9B are partially enlarged views showing a relationship between an in-seal columnar spacer and a seal frame in a third embodiment of this disclosure, and FIG. 9A shows a state before superposition and FIG. 9B shows a state after superposition;

FIGS. 10A and 10B are partially enlarged views showing a relationship between an in-seal columnar spacer and a seal frame in a fourth embodiment of this disclosure; and FIG. 10A shows a state before superposition and FIG. 10B shows a state after superposition;

FIGS. 11A and 11B are partially enlarged views showing a relationship between an in-seal columnar spacer and a seal frame in a fifth embodiment of this disclosure, and FIG. 11A shows a state before superposition and FIG. 11B shows a state after superposition; and

FIGS. 12A and 12B are partially enlarged views showing a relationship between an in-seal columnar spacer and a seal frame in a sixth embodiment of this disclosure, and FIG. 12A shows a state before superposition and FIG. 12B shows a state after superposition.

### DETAILED DESCRIPTION

In each of the drawings and the description of illustrative embodiments, the same or similar reference numerals are applied to the same or similar parts. Further, a liquid crystal display panel refers to a configuration that a liquid crystal material is sandwiched between two substrates and peripheries thereof are held by a sealing material. Further, a liquid crystal display device has a configuration that display can be made by bonding a polarizing plate to both sides of a liquid crystal display panel, mounting a control substrate thereon and attaching a signal source thereto.

### First Embodiment

### Configuration of Liquid Crystal Display Device

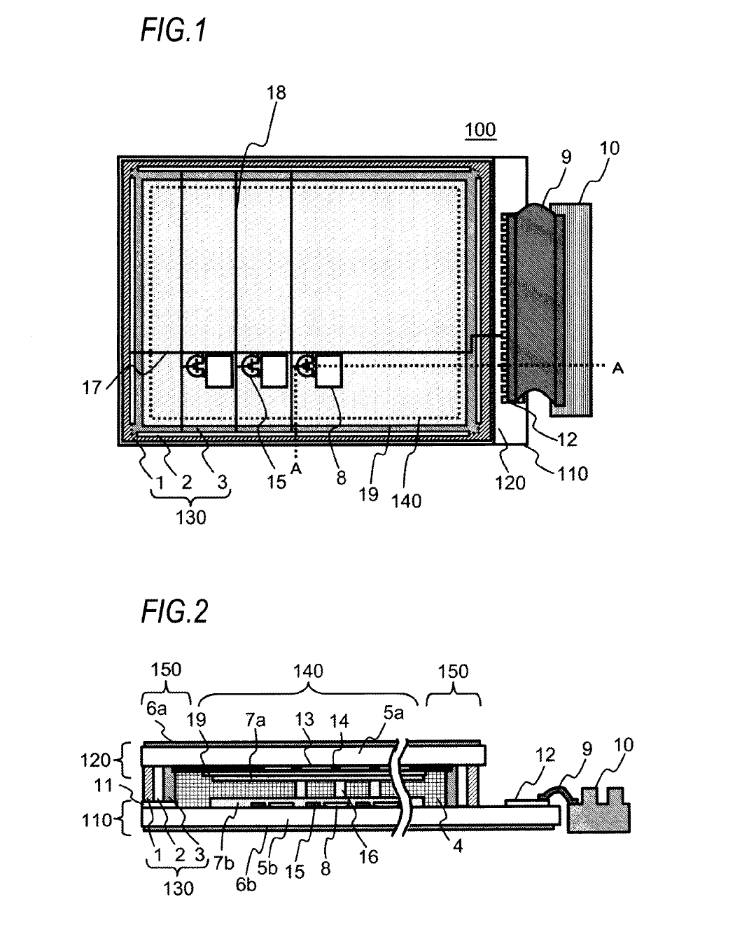

A configuration of a liquid crystal display device according to the present first embodiment will be described with reference to FIG. 1 and FIG. 2. FIG. 1 is a schematic plan view showing the liquid crystal display device of this disclosure, and FIG. 2 shows a schematic sectional view, taken along a part A-A indicated by a dashed line in FIG. 1.

The liquid crystal display device is mainly configured by a liquid crystal display panel 100 and a control substrate 10, which are electrically connected to each other via a flexible flat cable (FFC) 9, an anisotropic-conductive film (ACF; not shown) or the like.

The liquid crystal display panel 100 has a configuration that a liquid crystal material 4 is sandwiched between a thin film transistor (TFT) substrate 110 and a color filter (CF) substrate 120. A plurality of source wirings 18 and a plurality of gate wirings 17 are formed in the inner surface of the TFT substrate 110. Pixel regions configured by thin film transistors (TFT) 15 and pixel electrodes 8 are formed at intersections of the source wirings and the gate wirings. Further, a display region 140 is formed by a group of a plurality of pixels. An in-plane columnar spacer 16 is formed at the display region 140 on the inner surface of the TFT substrate 110 and an in-seal columnar spacer 2 is formed on the outer peripheral side of the display region 140. Furthermore, seal frames 1, 3 are respectively formed on the outer peripheral side of the in-seal columnar spacer 2 and on the portion between the inner peripheral side of the in-seal columnar spacer 2 and the outer peripheral side of the display region 140.

The display region 140 is configured by forming a black matrix (BM) 14 and a color filter (CF) 13 on the inner surface of the CF substrate 120 and forming a counter electrode 19 on the surface thereof. The liquid crystal display panel 100 is configured by sandwiching the liquid crystal material 4 between the CF substrate 120 and the TFT substrate 110 and holding two substrates by the seal frames 1, 3 which are formed on the outer peripheral side and the inner peripheral side of the above-described in-seal columnar spacer 2. Finally, a liquid crystal display device can be achieved by bonding polarization plates 6a, 6b to the outer surface of two substrates and mounting the control substrate 10 thereon.

### Configuration of Seal Frame

A configuration of a seal part 130 configured by the outer peripheral-side seal frame 1, the inner peripheral-side seal frame 3 and the in-seal columnar spacer 2 is at least an essential part of this disclosure and will be described in detail. Further, also in the description for a manufacturing method of the liquid crystal display panel 100 to be described later, the formation method and arrangements or the like of the seal part 130 that is an essential part of this disclosure will be described in detail.

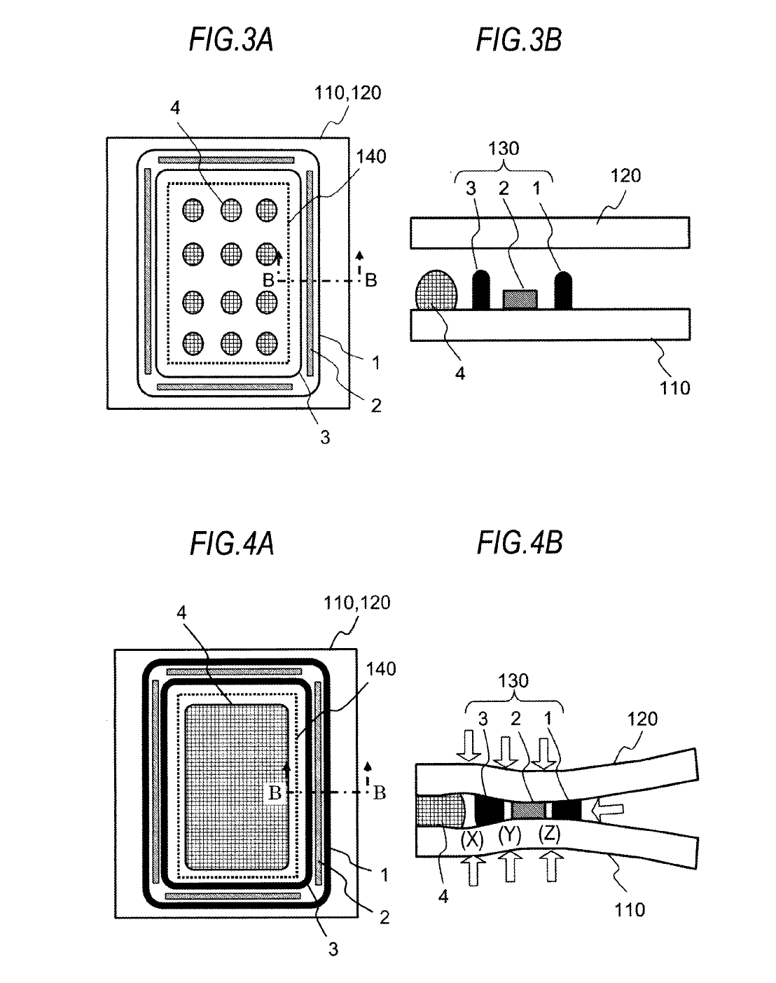

FIG. 3 to FIG. 5 show the changes in the shape of the seal frame in a formation and superposition process of the seal frame to the inner surface of the TFT substrate 110 and a forming procedure of the seal part. FIG. 3 to FIG. 5 are schematic views showing a manufacturing method of the liquid crystal display panel according to the first embodiment of this disclosure. In each of FIG. 3 to FIG. 5, figure A shows a schematic plan view of the liquid crystal display panel and figure B shows a schematic sectional view thereof, taken along a part B-B indicated by a dashed line in figure A.

The in-seal columnar spacer 2 is formed at the outer periphery of the display region 140 on the TFT substrate 110. In the present embodiment, the in-seal columnar spacer 2 has a linear shape along an outer periphery of each side of the display region 140 (FIG. 1, FIG. 3A) and is formed at four positions therearound.

On the surface of the TFT substrate 110 formed with the in-seal columnar spacer 2 and the CF substrate 120 opposing to the TFT substrate, the gate wirings 17, the source wirings 18 and a transfer pad 11 are also formed, as shown in FIG. 1 and FIG. 2. The transfer pad 11 is a terminal on the side of the TFT substrate 110 and provided for electrically connecting the TFT substrate 110 with the CF substrate 120. Therefore, it is necessary to determine a height of the in-seal columnar spacer 2 in consideration of these surface irregularities of the TFT substrate 110. Further, it is necessary to adjust a thickness of the liquid crystal material 4 so that the thickness is uniform in the plane and has a desired value. Further, the electrical connection between two substrates is made by adding conductive particles into the seal material and electrically connecting the transfer pad 11 on the TFT substrate 110 with the counter electrode 19 on the CF substrate 120. The conductive particles are spherical resin to which metal plating or the like is applied.

The seal frames 1, 3 are formed on the TFT substrate 110 where the in-seal columnar spacer 2 is formed. The outer peripheral-side seal frame 1 is formed on the outside of the in-seal columnar spacer 2, and the inner peripheral-side seal frame 3 is formed on the inside thereof. The liquid crystal material 4 is dropped on the inside of the inner peripheral-side seal frame 3. The TFT substrate 110 is placed while maintaining a constant gap with the CF substrate 120 (FIG. 3) and, in this state, a space between the substrates and the surroundings of the substrates are depressurized. In the depressurized state, two substrates are bonded to each other (FIG. 4). When the surroundings of the substrates in the bonded state return to a normal pressure, each region indicated by (X), (Y) and (Z) in FIG. 4B, that is, each region of a region (X) between the liquid crystal material 4 and the inner peripheral-side seal frame 3, a region (Y) between the inner peripheral-side seal frame 3 and the in-seal columnar spacer 2 and a region (Z) between the in-seal columnar spacer 2 and the outer peripheral-side seal frame 1 is maintained in the depressurized state. The substrates are pressed against each other by a force indicated by a white arrow, in response to the differential pressure between the surroundings and the regions. As a result, a panel gap that is a gap between two substrates is reduced, a line width of the seal frame is widened and each region of (X) to (Z) is reduced.

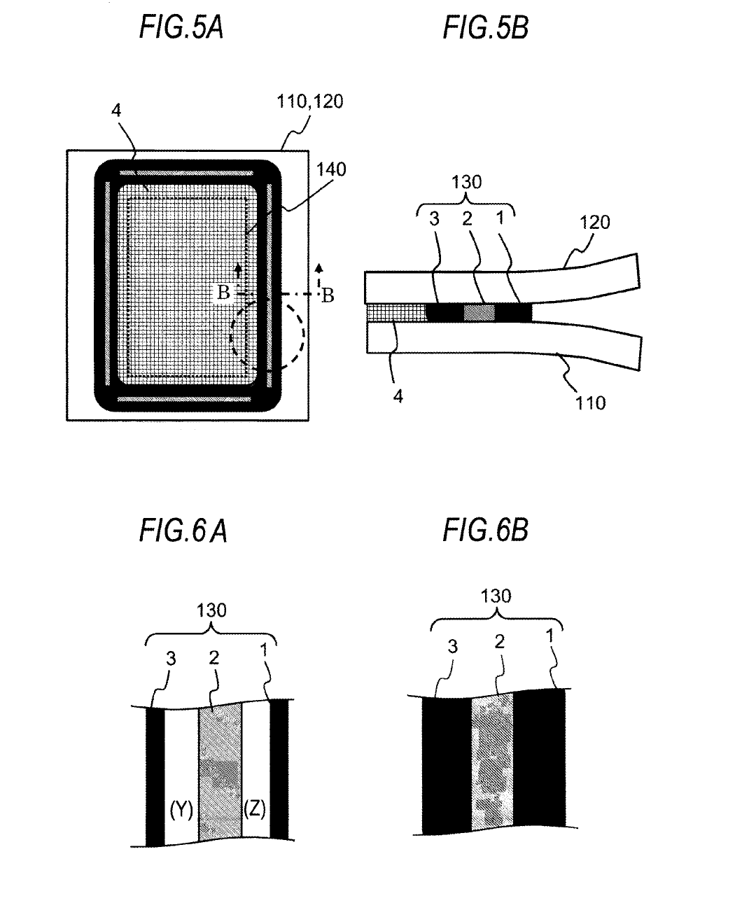

When time has elapsed and the panel gap between two substrates is reduced, each region of (X) to (Z) is lost so that the liquid crystal material 4 and the inner peripheral-side seal frame 3, the inner peripheral-side seal frame 3 and the in-seal columnar spacer 2, and the in-seal columnar spacer 2 and the outer peripheral-side seal frame 1 are in close contact with each other. In this way, two seal frames 1, 3 and the in-seal columnar spacer 2 are integrated to form the seal part 130 (FIG. 5). The seal part is temporarily cured by the irradiation of ultraviolet rays and then cured by heating, thereby obtaining the liquid crystal display panel 100.

FIG. 6 shows a schematic enlarged plan view of a dashed circle portion in the schematic plan view of the liquid crystal display panel after bonding, as shown in FIG. 5A. FIG. 6A shows a state immediately after superposition. In this state, a gap remains in the region of (Y) and (Z). FIG. 6B shows a state where a width of the seal material is widened by pressing and the region of (Y) and (Z) is lost. In the present embodiment, the in-seal columnar spacer 2 has a wall shape extending in a circumferential direction and a contact surface of the seal frames 1, 3 and the in-seal columnar spacer 2 has a linear shape. Therefore, a gap or the like is less likely to remain in the contact surface of the seal frames 1, 3 and the in-seal columnar spacer 2 and it is possible to form the seal part with a sufficient strength by integration of the seal frames 1, 3 and the in-seal columnar spacer 2, although an adhering force is somewhat insufficient.

Further, since the seal frames 1, 3 and the in-seal columnar spacer 2 are integrated without gaps, a width of the seal part 130 can be thinner than in the case where gaps remain between the seal frames 1, 3 and the in-seal columnar spacer 2. In this way, it is possible to obtain a liquid crystal display panel having a narrow frame. Furthermore, since the in-seal columnar spacer 2 is provided in the center of the seal part 130, there is no possibility that the panel gap is thinner than a desired value and thus it is possible to obtain the liquid crystal display panel 100 with excellent characteristics.

Although a desired thickness of the liquid crystal layer 4 varies according to the liquid crystal display mode to be used and the types of the liquid crystal material or the like, a proper thickness of the liquid crystal layer 4 is 2 to 5 μm in the case of an IPS (In-Plane Switching) type liquid crystal display device that is capable of achieving a wide viewing angle characteristic, for example. In the present embodiment, a thickness of the in-seal columnar spacer 2 is adjusted to a height where a thickness of the liquid crystal layer 4 is 3 μm. The in-seal columnar spacer 2 is formed by a photolithography using an ultraviolet curable resin.

It is necessary to adjust gaps between each of the outer peripheral-side seal frame 1 and the inner peripheral-side seal frame 3 and the in-seal columnar spacer 2 in accordance with the conditions of the superposition using one drop filling method for manufacturing the liquid crystal display panel 100. Specifically, when it is intended to reduce the panel gap, it is necessary to widen gaps between each of the seal frames 1, 3 and the in-seal columnar spacer 2 or to reduce the application amount of each of the seal frames 1, 3. On the contrary, when it is intended to increase the panel gap, it is necessary to reduce gaps between each of the seal frames 1, 3 and the in-seal columnar spacer 2 or to increase the application amount of each of the seal frames 1, 3. Namely, it is necessary to adjust the gaps between each of the seal frames 1, 3 and the in-seal columnar spacer 2 and the application amount of the seal material or the like, in response to the superposition conditions using the one drop filling method as described above.

### Manufacturing Process of Liquid Crystal Display Panel

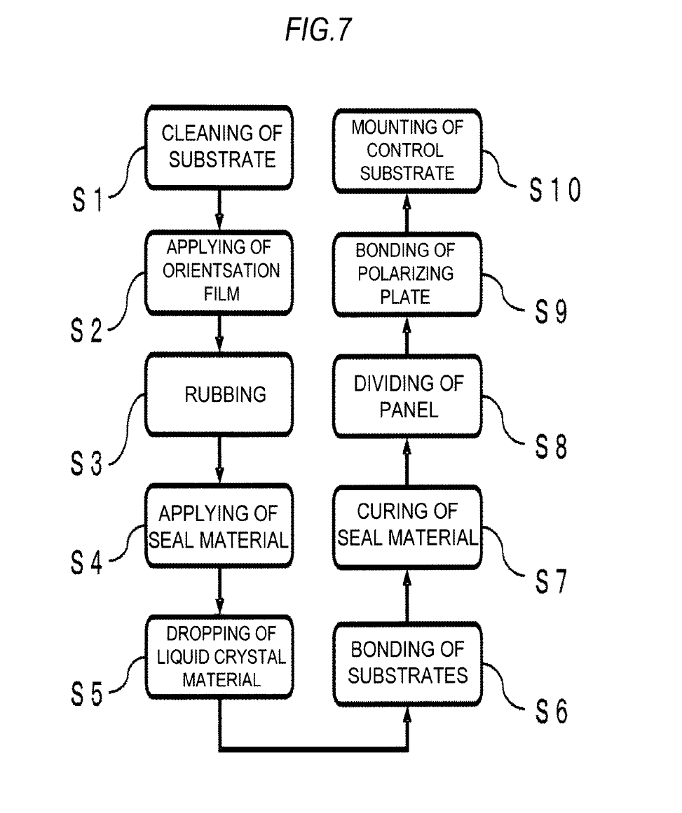

A manufacturing process of the liquid crystal display device described in the present embodiment will be described. FIG. 7 shows a flow of a manufacturing process of the liquid crystal display device after manufacturing the TFT substrate 110 and the CF substrate 120. The manufacturing process of the TFT substrate 110 and the CF substrate 120 is not directly related to this disclosure but can employ a conventional method. Accordingly, only an overview of the process will be described.

The TFT 15, the gate wirings 17, the source wirings 18 and the pixel electrodes 8 or the like are formed on one side of a glass substrate 5b by repeatedly executing a pattern forming process including a film forming process, a patterning process using a photolithography method and an etching process, thereby obtaining the TFT substrate 110. Further, the CF 13, the BM 14 and the counter electrode 19 to configure the display region 140 are formed on one side of a glass substrate 5a, thereby obtaining the CF substrate 120.

Then, a photosensitive resin film is formed on the surface of the TFT substrate 110 and then patterned to make the in-seal columnar spacer 2 and the in-plane columnar spacer 16. As described above, the in-seal columnar spacer 2 is formed at the outer peripheral portion of the display region 140 on the substrate, and the in-plane columnar spacer 16 is formed at the portion where the display between pixels in the display region 140 is not easily affected. A photosensitive epoxy, acrylic or the like can be used as the photosensitive resin film. The in-seal columnar spacer 2 and the in-plane columnar spacer 16 may be manufactured in a single process when the required height thereof is the same as each other. Further, the in-seal columnar spacer 2 and the in-plane columnar spacer 16 may be manufactured in a separate process when the required height thereof is different from each other.

Although a columnar spacer using a photolithography method is used as the in-plane columnar spacer 16 in the present embodiment, a conventional beads-like spacer dispersed in the plane may be used. Further, the in-seal columnar spacer 2 can be made by using the same material and process as the in-plane columnar spacer 16 used also in a conventional liquid crystal display panel 100 and changing only the shape thereof. The shape of the spacer is not necessarily columnar. Here, the columnar spacer corresponds to a spacer that is formed on a substrate surface by a photolithography method or the like, rather than a spacer that is generally dispersed.

Although both the in-seal columnar spacer 2 and the in-plane columnar spacer 16 are formed on the TFT substrate 110 in the present embodiment, this disclosure is not limited to this configuration. For example, one or both of the in-seal columnar spacer 2 and the in-plane columnar spacer 16 may be formed on the CF substrate 120.

By using the TFT substrate 110 and the CF substrate 120 manufactured as described above, a liquid crystal display panel can be assembled in accordance with the process shown in FIG. 7. The TFT substrate 110 and the CF substrate 120 manufactured are cleaned (S1) and dried. Then, an orientation film material is applied to the surfaces of both substrates. The orientation film material is applied by a printing method and heated and fired by a hot plate or the like (S2). As the orientation film material, polyimide solution, amic acid solution or the like can be used. Orientation films 7a, 7b formed on the TFT substrate 110 and the CF substrate 120 are subjected to a liquid crystal orientation processing by a rubbing (S3).

A seal material is applied on the TFT substrate 110 having the columnar spacers 2, 16 formed thereon by a dispenser, thereby continuously forming the annular seal frames 1, 3. The positions where the seal material is applied and the seal frames 1, 3 are formed are set on the outer peripheral side (outer peripheral-side seal frame 1) and the inner peripheral side (inner peripheral-side frame 3) of the formation portion of the in-seal columnar spacer 2, as described above (S4). Although the seal frames 1, 3 are formed by applying the seal material to the TFT substrate 110 in the present embodiment, the seal frames may be formed on the CF substrate 120.

The liquid crystal material 4 is dropped on the TFT substrate 110 having the seal frames 1, 3 formed thereon using the dispenser. The dropping of the liquid crystal material 4 is performed on the inside of the inner peripheral-side seal frame 3. Further, the dropping of the liquid crystal material 4 is performed in multiple places, instead of one place (S5).

The TFT substrate 110 having the liquid crystal material 4 dropped thereon and the CF substrate 120 as a counter substrate are placed to face each other while leaving a constant gap therebetween. Since a detailed process of the superposition has been already described, a brief description thereof is made herein. The whole of the two substrates 110, 120 placed to face each other is depressurized so that not only the portion between the substrates but also the portion around the substrates is depressurized. Subsequently, the two substrates are bonded in a state of being depressurized and the liquid crystal material 4 and the seal frames 1, 3 or the like are in close contact between the two substrates 110, 120. Then, when dry nitrogen is introduced into the region around the substrates, two substrates 110, 120 are pressed by the pressure difference between the inside of the liquid crystal display panel 100 and the portion around the substrates, so that the seal frames 1, 3 are integrated with the in-seal columnar spacer 2 (S6).

The gap between the seal frames 1, 3 and the in-seal columnar spacer 2 is lost so that the seal frames 1, 3 are integrated with the in-seal columnar spacer 2. Further, the seal material is cured by irradiating, with light, the seal frames 1, 3 after the region where the liquid crystal is not injected is absent in the display region 140 (S7). Then, when the seal material is further heated by a further heating, the seal material is further cured and therefore it is possible to obtain a liquid crystal display panel with high reliability.

Finally, unnecessary portions of the glass substrates 5a, 5b are cut and removed (S8) to obtain the liquid crystal display panel 100. Further, the polarizing plates 6a, 6b are bonded to the outer surfaces on the upper and lower sides of the liquid crystal display panel 100 (S9) and the control substrate 10 is mounted on a mounting pad using the ACF (Anisotropic-Conductive Film) (S10). In this way, the liquid crystal display device is achieved.

In the liquid crystal display panel 100 that can be achieved in the present embodiment, two seal frames 1, 3 are integrated with the in-seal columnar spacer 2 by being in close contact therewith. Accordingly, a width of the seal part 130 is relatively narrow and therefore it is possible to obtain the display where the frame region 150 is narrow. Further, since the panel gap can be uniformly maintained by the in-seal columnar spacer 2, the display unevenness is less. Further, since the portion of the glass substrates bonded by the seal material is not cut, it is possible to obtain the liquid crystal display panel 100 with a high yield by a panel diving process.

### Second Embodiment

The present embodiment has the same basic configuration as the first embodiment but is characterized in that the shape of the in-seal columnar spacer 2 is different.

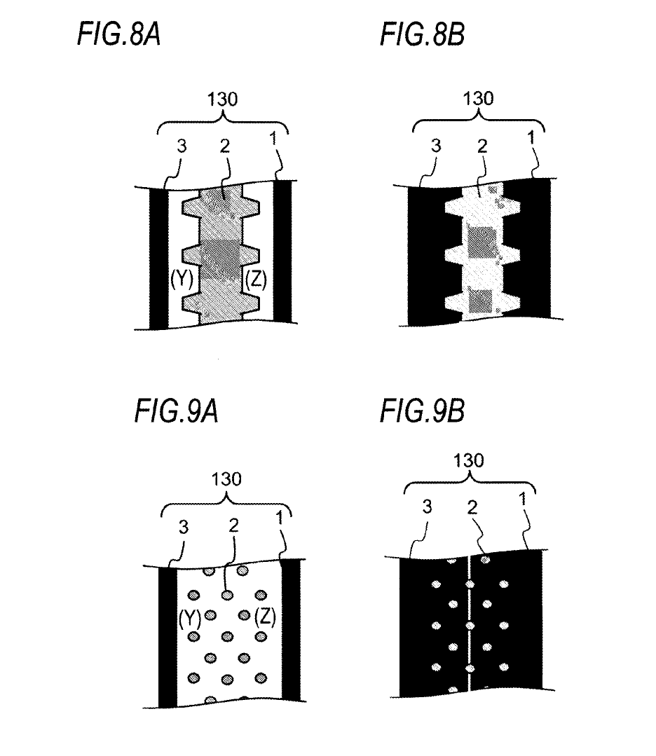

FIG. 8 shows a schematic enlarged plan view of a liquid crystal display panel 100 of the present embodiment, corresponding to a dashed circle portion in the schematic plan view shown in FIG. 5A. FIG. 8A shows a state where the seal frames 1, 3 are formed, and FIG. 8B shows a state where a seal width is widened by the pressing of the substrates, the gaps (Y), (Z) between the seal frames 1, 3 and the in-seal columnar spacer 2 are lost and the seal frames 1, 3 are integrated with the in-seal columnar spacer 2. As compared to the in-seal columnar spacer 2 shown in the first embodiment where the in-seal columnar spacer 2 has a wall shape (FIG. 6A and B) extending in a circumferential direction, the in-seal columnar spacer 2 of the present embodiment is characterized in that irregularities are formed on the contact surface between the in-seal columnar spacer 2 and the seal frames 1, 3 and therefore the area of the contact surface increases.

Since convex portions are formed on the side of the in-seal columnar spacer 2, the contact area between the seal frames 1, 3 and the in-seal columnar spacer 2 increases. Accordingly, it is possible to further increase the strength of the seal part 130 when the seal frames 1, 3 are integrated with the in-seal columnar spacer 2. As a result, it is possible to obtain the liquid crystal display panel 100 where a narrow frame is possible, there is no display unevenness and reliability is high.

### Third Embodiment

The present embodiment has the same basic configuration as the first embodiment but is characterized in that the shape of the in-seal columnar spacer 2 is different. FIG. 9 shows a schematic enlarged plan view of a liquid crystal display panel 100 of the present embodiment, corresponding to a dashed circle portion in the schematic plan view shown in FIG. 5A. FIG. 9A shows a state where the seal frames 1, 3 are formed, and FIG. 9B shows a state where a seal width is widened by the pressing of the substrates and the seal frames 1, 3 are integrated with the in-seal columnar spacer 2. Further, a white line in the center of FIG. 9B schematically show the contact portion where the outer peripheral-side seal frame 1 and the inner peripheral-side seal frame 3 are in contact with each other when the line width thereof is widened by the pressing of two substrates 110, 120.

The present embodiment is characterized in that the in-seal columnar spacer 2 is configured by a plurality of parts which is formed along the outer periphery of the display region. Since the shape of the in-seal columnar spacer 2 has a plurality of independent circular shapes, as shown in FIG. 9, the contact surface between the columnar spacer 2 and the seal frames 1, 3 is complicated and the seal frames 1, 3 are directly in close in contact with each other. It is possible to further increase the strength of the seal part 130 when the seal frames 1, 3 are integrated with the in-seal columnar spacer 2. With this configuration, a narrow frame is possible and there is no display unevenness. As a result, it is possible to obtain the liquid crystal display panel 100 with high reliability.

### Fourth Embodiment

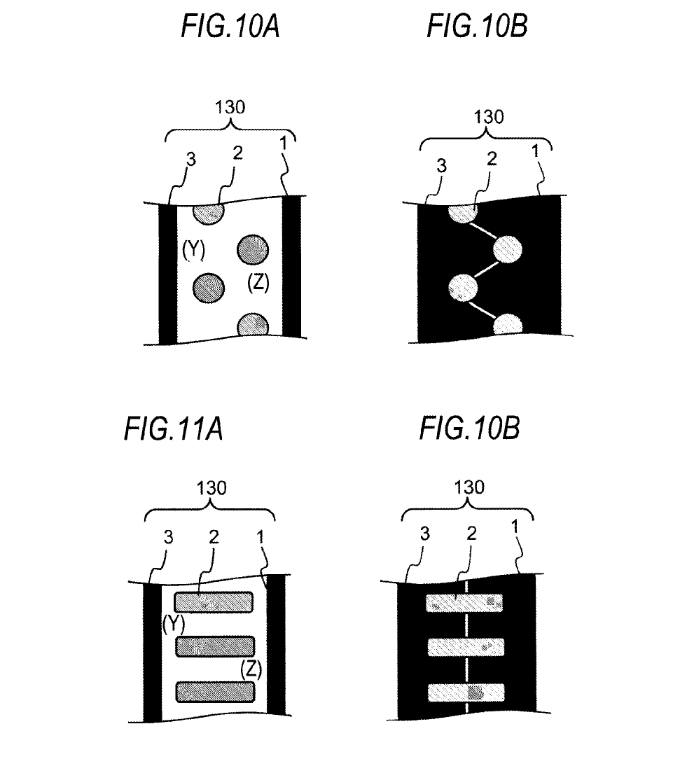

The present embodiment has the same basic configuration as the first embodiment but is characterized in that the shape of the in-seal columnar spacer 2 is different. FIG. 10 shows a schematic enlarged plan view of a liquid crystal display panel of the present embodiment, corresponding to a dashed circle portion in the schematic plan view shown in FIG. 5A. FIG. 10A shows a state where the seal frames 1, 3 are formed, and FIG. 10B shows a state where a seal width is widened by the pressing of the substrates and the seal frames 1, 3 are integrated with the in-seal columnar spacer 2. Further, a white line in the center of FIG. 10B schematically shows the contact portions between the outer peripheral-side seal frame 1 and the inner peripheral-side seal frame 3, similar to FIG. 9B.

The present embodiment is characterized in that the in-seal columnar spacer 2 is configured by a plurality of parts which is arranged without being overlapped in an outward direction from the display region 140. Since the shape of the in-seal columnar spacer 2 has a plurality of independent circular shapes which is arranged without being overlapped in the outward direction from the display region 140, as shown in FIG. 10, it is possible to obtain the liquid crystal display panel 100 where the width of the seal frames 1, 3 is smoothly widened by the pressing of two substrates and there is no display unevenness due to unevenness in the panel gap. Further, since the seal frames 1, 3 are directly in close contact with each other, it is possible to increase the strength of the seal part 130. As a result, it is possible to obtain the liquid crystal display panel 100 with high reliability.

### Fifth Embodiment

The present embodiment has the same basic configuration as the first embodiment but is characterized in that the shape of the in-seal columnar spacer 2 is different. FIG. 11 shows a schematic enlarged plan view of a liquid crystal display panel of the present embodiment, corresponding to a dashed circle portion in the schematic plan view shown in FIG. 5A. FIG. 11A shows a state where the seal frames 1, 3 are formed, and FIG. 11B shows a state where a seal width is widened by the pressing of the substrates and the seal frames 1, 3 are integrated with the in-seal columnar spacer 2.

The present embodiment is characterized in that the in-seal columnar spacer 2 has a rectangular shape extending in the outward direction from the display region 140. Since the shape of the in-seal columnar spacer 2 has a plurality of independent rectangular shapes which is arranged without being overlapped in the outward direction from the display region 140, as shown in FIG. 11, it is possible to obtain the liquid crystal display panel 100 where the width of the seal frames 1, 3 is smoothly widened by the pressing of two substrates and there is no display unevenness due to unevenness in the panel gap. Further, since the seal frames 1, 3 are directly in close contact with each other, it is possible to increase the strength of the seal part 130. As a result, it is possible to obtain the liquid crystal display panel 100 with high reliability.

### Sixth Embodiment

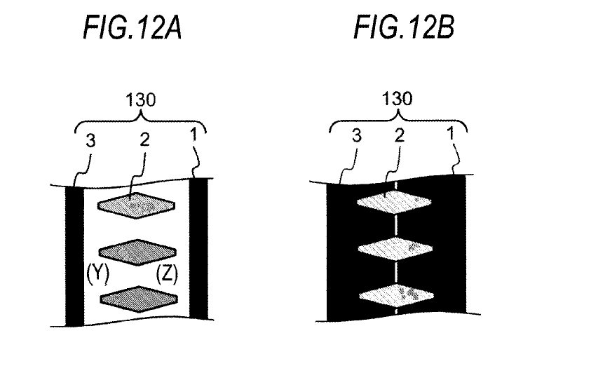

The present embodiment has the same basic configuration as the first embodiment but is characterized in that the shape of the in-seal columnar spacer 2 is different. FIG. 12 shows a schematic enlarged plan view of a liquid crystal display panel of the present embodiment, corresponding to a dashed circle portion in the schematic plan view shown in FIG. 5A. FIG. 12A shows a state where the seal frames 1, 3 are formed, and FIG. 12B shows a state where a seal width is widened by the pressing of the substrates and the seal frames 1, 3 are integrated with the in-seal columnar spacer 2.

The present embodiment is characterized in that the in-seal columnar spacer 2 has a diamond-like shape extending in the outward direction from the display region 140. Since the shape of the in-seal columnar spacer 2 has a plurality of independent diamond-like shapes which is arranged without being overlapped in the outward direction from the display region 140, as shown in FIG. 12, it is possible to obtain the liquid crystal display panel 100 where the width of the seal frames 1, 3 is smoothly widened by the pressing of two substrates and there is no display unevenness due to unevenness in the panel gap. Further, since the seal frames 1, 3 are directly in close contact with each other, it is possible to increase the strength of the seal part 130. As a result, it is possible to obtain the liquid crystal display panel 100 with high reliability.

What is claimed is:

1. A liquid crystal display panel comprising:
two substrates, whose inner surfaces are formed with a display region, which are arranged to face each other and at least one of which is transparent;
a liquid crystal material, which is sandwiched between the display region of the two substrates;
a columnar spacer, which is formed on the inner surface of the substrate and on the outer periphery of the display region and maintains a gap between the two substrates;
a first annular seal frame, which is continuously formed on the inner periphery of the columnar spacer and on the outer periphery of the display region; and
a second annular seal frame, which is continuously formed on the outer periphery of the columnar spacer.

2. The liquid crystal display panel according to claim 1,
wherein the first seal frame and the second seal frame are integrated with interposing the columnar spacer.

3. The liquid crystal display panel according to claim 2,
wherein the columnar spacer comprises a plurality of parts which is formed along the outer periphery of the display region.

4. The liquid crystal display panel according to claim 3,
wherein the parts of the columnar spacer are arranged without being overlapped in an outward direction from the display region.

5. The liquid crystal display panel according to claim 4,
wherein the columnar spacer has a shape extending in the outward direction from the display region.

6. The liquid crystal display panel according to claim 2,
wherein the columnar spacer has a wall shape which is formed on the outer periphery of the display region and extends along a circumferential direction of the display region.

7. The liquid crystal display panel according to claim 6,
wherein the surface of the columnar spacer formed in the wall shape, which is integrated by being in close contact with the first and second seal frames, has a convex portion.

8. A manufacturing method of a liquid crystal display panel comprising:
forming a columnar spacer on the outer periphery of a display region which is formed on the inner surfaces of two substrates, at least one of the two substrates being transparent;
forming a first annular seal frame on the inner periphery of the columnar spacer and on the outer periphery of the display region;
forming a second annular seal frame on the outer periphery of the columnar spacer;
dropping a liquid crystal material in the first seal frame;
placing the two substrates to face each other and causing the surroundings of the substrates including the portion between the substrates to be in a first pressure;
superimposing the two substrates and then causing the surroundings of the substrates to be in a second pressure higher than the first pressure;
pressing the two substrates by a difference between the first pressure and the second pressure to widen a line width of the seal frames and integrating the columnar spacer with the first seal frame and the second seal frame; and
curing the integrated seal frames.

9. The manufacturing method of the liquid crystal display panel according to claim 8,
wherein the columnar spacer comprises a plurality of parts which is formed along the outer periphery of the display region.

10. The manufacturing method of the liquid crystal display panel according to claim 9,
wherein the parts of the columnar spacer are arranged without being overlapped in an outward direction from the display region.

11. The manufacturing method of the liquid crystal display panel according to claim 10,
wherein the columnar spacer has a shape extending in the outward direction from the display region.

12. The manufacturing method of the liquid crystal display panel according to claim 8,
wherein the columnar spacer has a wall shape which is formed on the outer periphery of the display region and extends along a circumferential direction of the display region.

13. The manufacturing method of the liquid crystal display panel according to claim 12,
wherein the surface of the columnar spacer formed in the wall shape, which is integrated by being in close contact with the first and second seal frames, has a convex portion.
